(19) United States
(12) Patent Application Publication
(10) Pub. No.: US 2011/0199656 A1
(43) Pub. Date: Aug. 18, 2011

(54) SHEET PROCESSING DEVICE AND FACSIMILE MACHINE

(76) Inventor: Takashi Suda, Osaka (JP)

(21) Appl. No.: 13/125,594

(22) PCT Filed: Jul. 14, 2010
(86) PCT No.: PCT/JP2010/061925

§ 371 Date: Apr. 22, 2011

(30) Foreign Application Priority Data
Jul. 31, 2009 (JP) 2009-179942

(51) Int. Cl. H04N 1/04; B65H 9/00; B65H 1/00

(52) U.S. Cl. 358/498; 271/241

(57) ABSTRACT

An object of the present invention is to prevent a sheet tray from opening against the user's will when a cover is in an open state without adding a complicated mechanism. In a facsimile machine (1), a recording paper tray (10) is provided with a projecting section (11) turning in association with the turning of the recording paper tray (10) turnably attached to a maintenance cover (20), and a paper feeding guide (30) is provided with a locking section (31) which, (i) when the maintenance cover (20) is in an open state, moves to a locking position in association with the turning of the paper feeding guide (30) turnably attached to the maintenance cover (20), the locking position being a position at which the locking section (31) locks the projecting section (11) so as to prevent the turning of the recording paper tray (10), and (ii) when the maintenance cover (20) is in a closed state, moves to a releasing position in association with the turning of the paper feeding guide (30) turnably attached to the maintenance cover (20), the releasing position being a position at which the locking section (31) releases the projecting section (11) so as to enable the turning of the recording paper tray (10).

### TECHNICAL FIELD

The present invention relates to a sheet processing device for processing sheets, and a facsimile machine.

### BACKGROUND ART

Conventionally, as a facsimile machine or the like, there is a facsimile machine or the like which includes a recording paper tray to which a sheet of recording paper is to be set, and a paper feeding guide for carrying the sheet of recording paper set on the recording paper tray to a processing section for carrying out a printing process.

There is also a facsimile machine or the like in which the recording paper tray can be stored (e.g., folded down, closed up, pulled inside, etc.) when the facsimile machine is not in use. For example, there is a facsimile machine or the like with the recording paper tray axially turnably attached to a cover, wherein the recording paper tray is opened when the facsimile machine is used, while the recording paper tray can be kept closed when the facsimile machine is not in use.

These facsimile machines can be exemplified as below referring to FIGS. 7 and 8.

As illustrated in FIG. 7, a recording paper tray 110 is attached to a maintenance cover 120 covering an internal structure such as a printing processing section. The recording paper tray 110 is turnable about an axis P101 as a turning axis.

That is, the recording paper tray 110 can be opened and closed by turning the recording paper tray 110 along a trajectory T101 in the direction of an arrow K111 and in the direction of an arrow K112, respectively.

In this way, since the recording paper tray 110 can be opened and closed, it is possible to keep the recording paper tray 110 closed when the facsimile machine 100 is not in use as shown in FIG. 7.

When the facsimile machine 100 is used (in such cases as sending and receiving a facsimile and printing a received facsimile, for example), only the recording paper tray 110 is opened in the direction of the arrow K111 along the trajectory T101, as shown in FIG. 8.

The maintenance cover 120 is provided with a paper feeding guide 130 for guiding a sheet of recording paper from the recording paper tray 110 to the processing section for carrying out a printing process. That is, the paper feeding guide 130 forms a carrying path for carrying the sheet of recording paper to the processing section in FIG. 8. Here, the paper feeding guide 130 is attached to the maintenance cover 120 turnably about an axis P103 serving as a turning axis.

As for structures of conventional facsimile machines or the like, ones as shown in the following patent documents 1 and 2 are known.

Patent document 1 discloses a structure for preventing a recording medium, which is set on a paper feeding section, from being damaged by a cover opened at a time of exchanging a printing agent supplying means.

Patent document 2 discloses a mechanism in which a protruding section provided at a hinge base of a cover and an opening section provided at a hinge receiver are engaged with each other so as to render the cover openable and closable, and in which, when an attempt is made to open the cover at an angle exceeding a predetermined angle, the engagement between the protruding section and the opening section is released, thereby preventing a damage to a hinge serving as a turning axis in opening and closing the cover.

Citation List

Patent Literature 1

Japanese Patent Application Publication, Tokukai, No. 2003-125160 A (Publication Date: Apr. 25, 2003)

Patent Literature 2

Japanese Patent Application Publication, Tokukai, No. 2006-203777 A (Publication Date: Aug. 3, 2006)

### SUMMARY OF INVENTION

### Technical Problem

In many of these facsimile machines, an openable and closable cover is provided for the purpose of maintenance and inspection of the facsimile machine such as replenishing ink or the like that is provided inside the machine, and solving paper jamming. The cover provides an access to the internal structure by being opened.

For example, as shown in FIG. 9, the maintenance cover 120 is attached to a housing 105 turnably along a trajectory T102 about an axis P102 serving as a turning axis. The maintenance cover 120 can open by turning in the direction of an arrow K121 about the axis P102 as the turning axis or close by turning in the direction of an arrow K122 about the axis P102 as the turning axis. In FIG. 9, the arrow F100 is pointing the front of the facsimile machine 100 and the arrow B100 is pointing the back of the facsimile machine 100.

In the case of a paper jamming or the like, which will require taking out of the sheet of recording paper by opening the maintenance cover 120 covering the internal structure as shown in FIG. 9, the paper feeding guide 130 moves to a position for releasing, from the carrying path, the sheet of recording paper being carried to the processing section.

In the conventional technology as exemplified in FIGS. 7 to 9, the recording paper tray 110 is attached to the maintenance cover 120 turnably irrespective of whether the maintenance cover 120 is open or closed. This leads to such an inconvenience that the recording paper tray 110 turns over, due to its own weight, to the back of the facsimile machine 100 when the maintenance cover 120 covering the internal structure is opened.

This is concretely explained below referring to FIG. 9. That is, as the maintenance cover 120 is gradually opened in the direction of the arrow K121 along the trajectory T102, the recording paper tray 110 turns over, due to its own weight, in the direction of the arrow K111 along the trajectory T101 to the limit of the operation range, along with the opening of the maintenance cover 120.

This results in such an inconvenience that, in the case where the facsimile machine is installed by a wall with the back of the facsimile machine facing against the wall, the recording paper tray is turned over against the user's will and collides against the wall when a user opens the cover to access the internal structure such as the processing section. In order to avoid such collision of the recording paper tray against the wall, the facsimile machine has to be installed spaced apart from the wall. That is, the installation of the facsimile machine requires an extra space.

Even in the case where the facsimile machine is installed spaced apart from the wall so as to prevent the recording paper tray from colliding against the wall, opening of the cover would swiftly turn over the recording paper tray, so as to apply too much load on a hinge section near the turning axis of the recording paper tray. The application of the load would break the hinge section.

Further, separately providing a component for fixing the recording paper tray to the cover to prevent such break of the hinge section leads to an increase in the number of components. This may invite an increase in production costs and complicates the mechanism of the facsimile machine.

The present invention is accomplished in view of the aforementioned problems. An object of the present invention is to achieve a sheet processing device and a facsimile machine in both of which a sheet tray is prevented from opening against the user's will when a cover is in an open state, without providing a complicated mechanism.

### Solution to Problem

In order to attain the object, a sheet processing device according to the present invention is a sheet processing device including: a processing section for processing a sheet; a cover turnably attached to a device body, the cover turning between a closed state for storing the processing section and an open state for exposing the processing section; a sheet tray for setting the sheet thereon, the sheet tray being turnably attached to the cover, so that the sheet tray is turnable with respect to the cover; and a guide for guiding the sheet set on the sheet tray to the processing section, the guide being turnably attached to the cover, so that the guide is turnable with respect to the cover; wherein the sheet tray is provided with a projecting section turning in association with the turning of the sheet tray turnably attached to the cover, and the guide is provided with a locking section which, (i) when the cover is in an open state, moves to a locking position in association with the turning of the guide turnably attached to the cover, the locking position being a position at which the locking section locks the projecting section so as to prevent the turning of the sheet tray, and (ii) when the cover is in a closed state, moves to a releasing position in association with the turning of the guide turnably attached to the cover, the releasing position being a position at which the locking section releases the projecting section so as to enable the turning of the sheet tray.

The sheet processing device of the present invention is a device for processing a thin plate or a sheet of paper. The sheet processing device is, for example, a printing device, a facsimile device, or the like.

The processing section included in the sheet processing device carries out, for example, a printing process such as printing on a sheet.

Here, the sheet tray is turnably attached to the cover. Therefore, when the cover gradually opens and reaches the open state in which the processing section is exposed, the sheet tray tries to turn, due to its own gravity, in the direction of opening of the cover.

According to the above configuration, when the cover is in the open state, the locking section moves to the locking position in association with the turning of the guide turnably attached to the cover, the locking position being a position at which the locking section locks the projecting section, so that the locking section can prevent the turning of the sheet tray.

On the other hand, when the cover is in the closed state, the locking section moves to the releasing position in association with the turning of the guide turnably attached to the cover, the releasing position being a position at which the locking section releases the projecting section, at which the locking section releases the projecting section. Thus, in this case, the turning of the sheet tray is not prevented by the locking section.

This is advantageous in that a complicated mechanism is not necessary to prevent the sheet tray from opening against the user's will when the cover is in the open state.

For example, in maintenance, it is possible to prevent the turning of the sheet tray even when the cover is in the open state.

Further, since it is possible to prevent the sheet tray from opening when the cover is in the open state, no extra space is needed in installation of the device. Also, it is possible to avoid load that may otherwise be applied around the turning axis due to an impact when the sheet tray opens.

In addition, since there is no need of additionally providing a component for preventing the turning of the sheet tray, complication of the mechanism of the sheet processing device can be prevented and increases in the number of components and production costs can be avoided.

### ADVANTAGEOUS EFFECTS OF INVENTION

According to the sheet processing device of the present invention, the sheet tray is provided with the projecting section turning in association with the turning of the sheet tray turnably attached to the cover, and the guide is provided with the locking section which, (i) when the cover is in the open state, moves to the locking position in association with the turning of the guide turnably attached to the cover, the locking position being a position at which the locking section locks the projecting section so as to prevent the turning of the sheet tray, and (ii) when the cover is in the closed state, moves to the releasing position in association with the turning of the guide turnably attached to the cover, the releasing position being a position at which the locking section releases the projecting section so as to enable the turning of the sheet tray.

Therefore, without a complicated mechanism it is possible to prevent the sheet tray from opening against the user's will when the cover is in the open state.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1

FIG. 1 is a schematic view and an enlarged view of a facsimile machine and a main part thereof in accordance with one embodiment of the present invention, and illustrates the facsimile machine when a maintenance cover is in an open state.

FIG. 2

FIG. 2 is a top view showing an outer appearance of the facsimile machine.

FIG. 3

FIG. 3 is an exploded perspective view of the facsimile machine.

FIG. 4

FIG. 4 is a schematic cross-sectional view of the facsimile machine and an enlarged view of a main part thereof and illustrates the facsimile machine when the maintenance cover and a recording paper tray are in closed states.

FIG. 5

FIG. 5 is a schematic cross-sectional view of the facsimile machine and an enlarged view of a main part thereof and illustrates the facsimile machine when the maintenance cover is in a closed state and the recording paper tray is an open state.

FIG. 6

FIG. 6 is a schematic cross-sectional view of the facsimile machine and an enlarged view of a main part thereof and illustrates the facsimile machine when the maintenance cover is in an open state.

FIG. 7

FIG. 7 is a schematic cross-sectional view showing a conventional facsimile machine.

FIG. 8

FIG. 8 is a schematic cross-sectional view showing a conventional facsimile machine.

FIG. 9

FIG. 9 is a schematic cross-sectional view showing a conventional facsimile machine.

### DESCRIPTION OF EMBODIMENTS

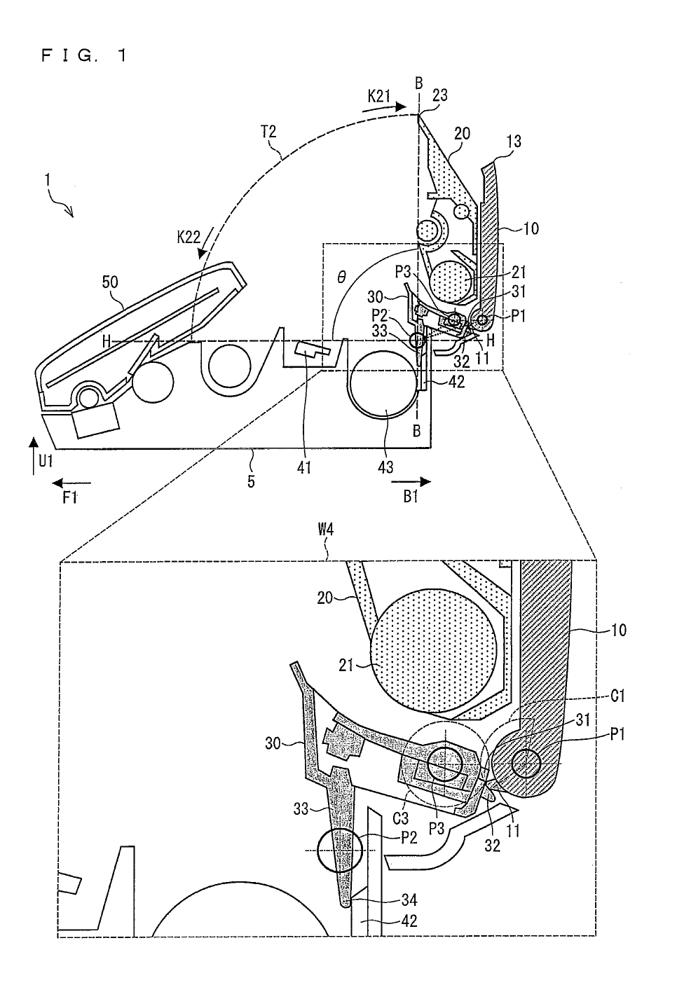

One embodiment of a sheet processing device of the present invention will be described below with reference to FIGS. 1 to 6.

In this embodiment, a facsimile machine 1 as a sheet processing device will be described.

[Outer Appearance of Sheet Processing Device]

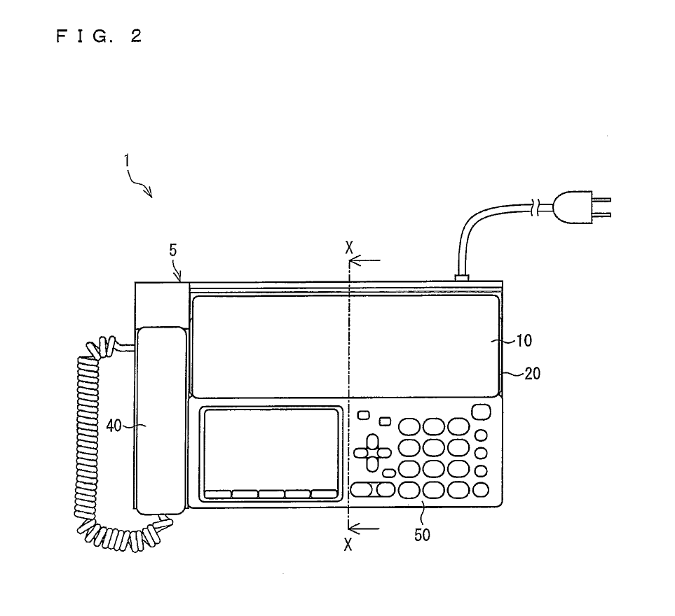

First, the outer appearance of the facsimile machine (sheet processing device) 1 will be described referring to FIG. 2, which is a top view showing the outer appearance of the facsimile machine 1.

As shown in FIG. 2, the facsimile machine 1 includes a housing (device body) 5, a recording paper tray (sheet tray) 10, a maintenance cover (cover) 20, a receiver (40), and a front panel 50.

In this embodiment, the facsimile machine 1 is described via one non-limiting example thereof equipped with a facsimile transmitting function for transmitting and receiving a facsimile, a facsimile printing function for printing a received facsimile, and a telephone function and the like. Also, for easy explanation, the facsimile machine 1 is described via one non-limiting example thereof capable of storing a received facsimile in a built-in memory in the device as facsimile data by the facsimile receiving function and of printing the content of the facsimile data stored in the memory by the facsimile printing function.

The housing 5 is adapted for mounting therein a configuration for realizing various functions such as transmitting and receiving a facsimile and printing. For example, although not shown in FIG. 2, the housing 5 mounts therein a CIS (Contact Image Sensor) for reading out content from a sheet in transmitting the content of the sheet by facsimile, a communication section for realizing the facsimile transmitting and receiving function, a memory for storing various pieces of setting information and a received facsimile, a printing processing section for printing facsimile data, and a control section for carrying out various controls and the like. Details of the printing processing section will be described later.

The recording paper tray 10 is adapted for setting a sheet of recording paper thereon for facsimile printing. The recording paper tray 10 is turnably attached to the maintenance cover 20 and is openable and closable. While FIG. 2 shows a closed state in which the recording paper tray 10 is closed, the facsimile machine 1 is used in an open state in which the recording paper tray 10 is open in facsimile printing. Details of the open and closed states of the recording paper tray 10 will be described later.

The sheet of recording paper set on the recording paper tray 10 is fed to the inside of the device by a paper feeding guide 30 (FIG. 1), and printing is carried out at the printing processing section including a thermal head and the like. Details of the paper feeding guide 30 will be described later.

The recording paper tray 10 may include a storable extension tray so that the length of the recording paper tray 10 in the direction of feeding the sheet of recording paper can be extended. That is, the facsimile machine 1 may be configured such that the sheet of recording paper can be held with the extension tray included in the recording paper tray 10 pulled out in facsimile printing.

The maintenance cover 20 is a part of an outer covering for storing the processing section for realizing various functions such as transmitting and receiving a facsimile and printing. The maintenance cover 20 is turnably attached to the housing 5 and is openable and closable.

In the case of using the various functions equipped in the facsimile machine 1, the maintenance cover 20 is normally used in a closed state, namely, a closed state in which the processing section for realizing the various functions is stored by means of the maintenance cover 20.

The maintenance cover 20 is opened when, for example, there is a need of accessing the processing section for maintenance purposes such as exchanging a ribbon and solving a jamming of a sheet of recording paper. That is, in maintenance, the maintenance cover 20 is brought in an open state in which the processing section is exposed for the purpose of accessing the processing section. In the following explanation, an attention will be paid to the printing processing section among the various processing sections for the convenience of explanation. Details of the open and closed states of the maintenance cover 20 will be described later.

The receiver 40 is adapted for telecommunications by means of the telephone function. The front panel 50 includes a display section (not shown) for providing various pieces of information to the user and an operation section (not shown) for receiving an operation input by the user.

[Assembly of Components of Facsimile Machine]

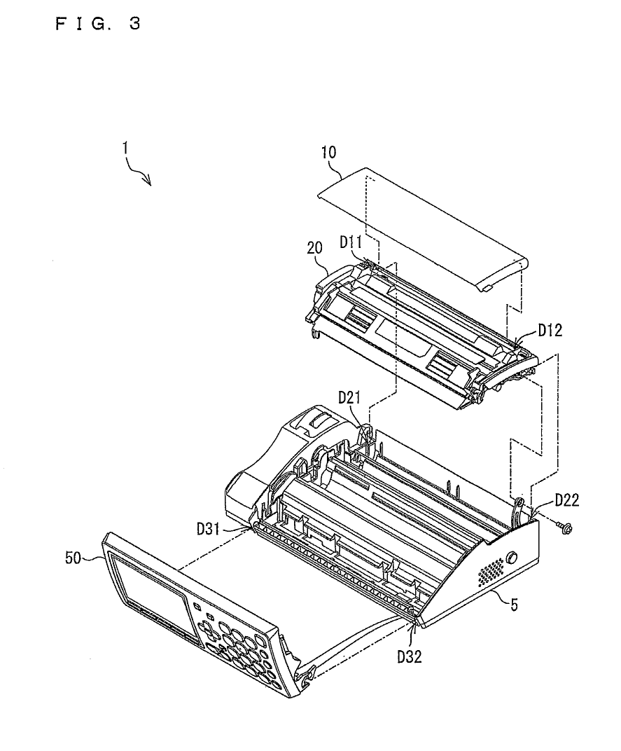

Next, assembly of components of the facsimile machine 1 will be described with reference to FIG. 3, which is an exploded perspective view of the facsimile machine 1. For easy explanation, FIG. 3 does not show any other configurations than those of the housing 5, the recording paper tray 10, the maintenance cover 20, and the front panel 50.

As shown in FIG. 3, components of the facsimile machine 1 are assembled as follows.

First, the recording paper tray 10 is connected to the maintenance cover 20 at connection sections D11, 12 provided to the maintenance cover 20 and is turnable about a line passing through the connection sections D11, 12 as a central axis of turning.

The maintenance cover 20 is connected to the housing 5 at connection sections D21, 22 provided to the housing 5 and is turnable about a line passing through the connection sections D21, 22 as a central axis of turning.

The front panel 50 is connected to the housing 5 at connection sections D31, 32 provided to the housing 5 and is turnable about a line passing through the connection sections D31, 32 as a central axis of turning.

In this manner, each component is connected respectively at two connection sections in the facsimile machine 1. That is, no axial member is provided between the connection sections D11, 12, the connection sections D21, 22, and the connection sections D31, 32, respectively. In other words, the facsimile machine 1 allows efficient use of space due to having no axial member provided between the paired connection sections. However, not confined to this configuration, an axial member may be provided between the connection sections.

[Arrangements of Facsimile Machine with Recording Paper Tray and Maintenance Cover in Respective States]

Next, the recording paper tray 10, the maintenance cover 20, and the paper feeding guide 30 included in the facsimile machine 30 will be described referring to FIGS. 1, 4, 5, and 6.

FIGS. 1, 4, 5, and 6 are respectively cross-sectional views taken along arrow X-X in FIG. 2, and also schematic views and enlarged views of the main part thereof which respectively show arrangements of the facsimile machine 1 in respective states.

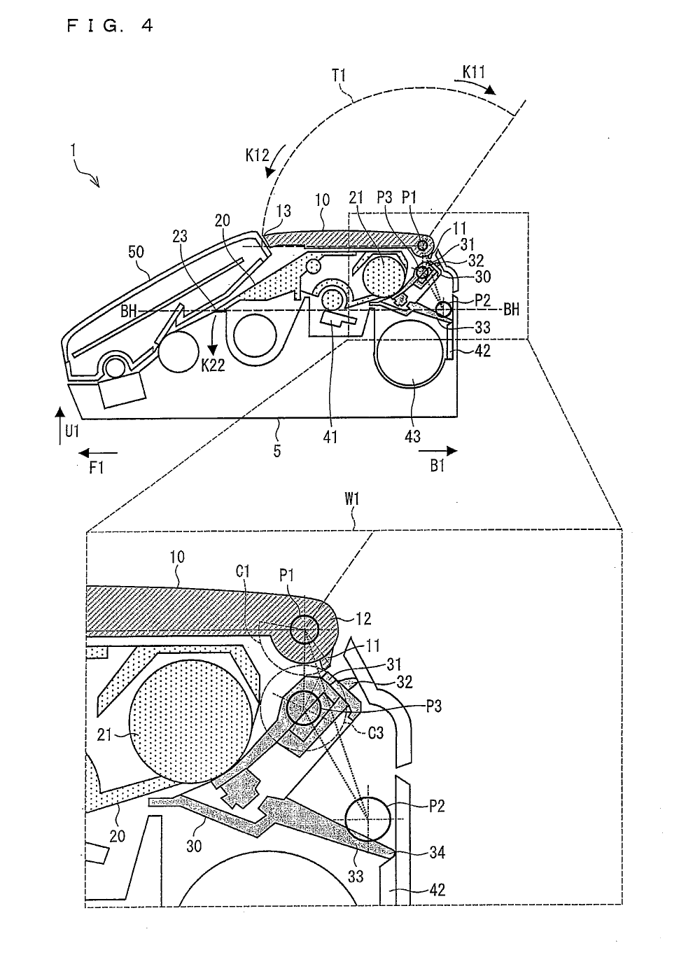

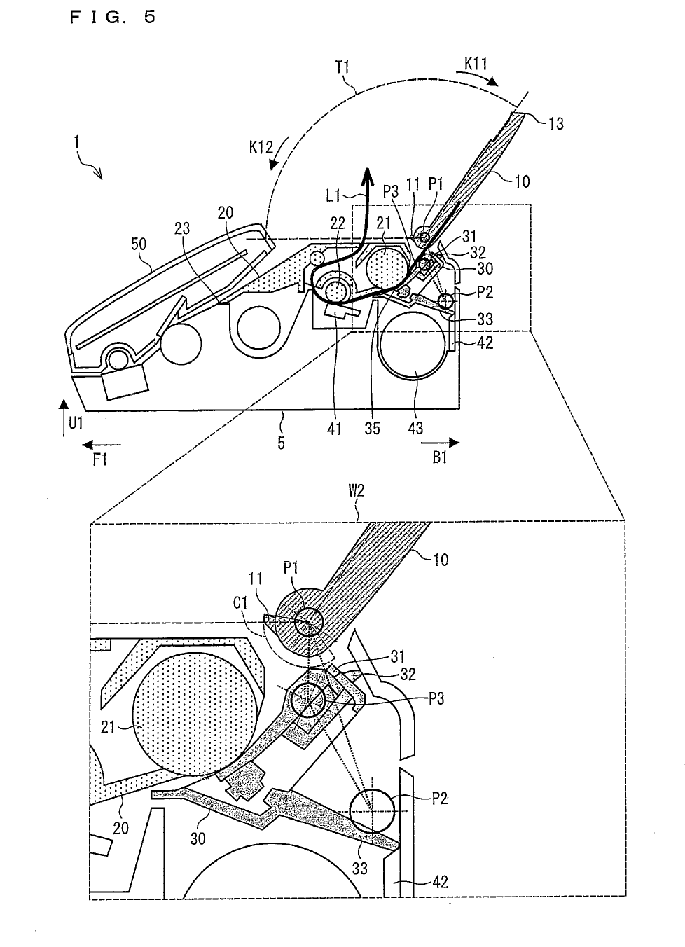

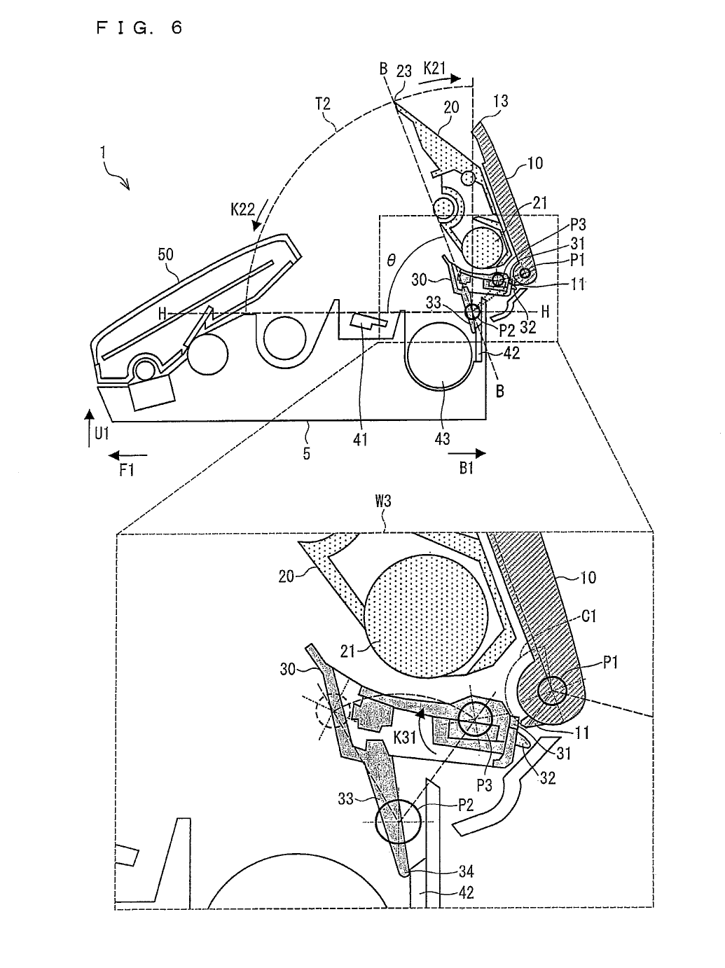

FIG. 4 shows an arrangement of the facsimile machine 1 when the recording paper tray 10 and the maintenance cover 20 are both in the closed states. FIG. 5 shows an arrangement of the facsimile machine 1 when the maintenance cover 20 is in the closed state and the recording paper tray 10 is in the open state. FIG. 6 shows an example of an arrangement of the facsimile machine 1 when the maintenance cover 20 is in the open state. FIG. 1 shows an arrangement of the facsimile machine 1 when the maintenance cover 20 is in the open state.

As shown in FIGS. 1, 4, 5, and 6, the recording paper tray 10 is turnably attached to the maintenance cover 20 about an axis P1, which is a line passing through the connection sections D11, 12 shown in FIG. 3, as a turning axis. The paper feeding guide 30 is turnably attached to the maintenance cover 20 about an axis P3 serving as a turning axis. The maintenance cover 20 is turnably attached to the housing 5 about an axis P2 serving as a turning axis. In FIG. 3, the axis P2 is a line passing through the connection sections D21, 22.

In other words, the recording paper tray 10 and the paper feeding guide 30 can respectively turn with respect to the maintenance cover 20.

Also, the recording paper tray 10 and the paper feeding guide 30 are respectively attached turnably to the maintenance cover 20 turnably attached to the housing 5. Therefore, when the maintenance cover 20 turns, the recording paper tray 10 and the paper feeding guide 30 respectively turn with respect to the housing 5 in association with the turning of the maintenance cover 20.

The recording paper tray 10 is provided with a projecting section 11. The maintenance cover 20 includes a paper feeding roller 21, and the paper feeding guide 30 is provided with a locking section 31, a projecting section (movement preventing section) 32, and a supporting section 33. A guiding section 42 is provided on the inner side of the outer covering of the back of the housing 5.

Within the housing 5 provided are a thermal head (processing section) 41 and a ribbon (processing section) 43. That is, the facsimile machine 1 according to this embodiment is illustrated as one in which the thermal head carries out a printing process by a thermal transfer method using a thermal transfer film of the ribbon 43.

The printing processing section includes the thermal head 41 and the ribbon 43, which are mounted in the housing 5, and a platen roller (processing section) 22 included in the maintenance cover 20. As this printing processing section, the processing section may include both the components of the housing 5 and the components of the maintenance cover 20. The present invention is not limited to this, and the processing section may be composed only of the components mounted in the housing 5 or of the components included in the maintenance cover 20. That is, the processing section can be composed of the components which are kept within the device by closing the maintenance cover 20.

[Open and Closed States of Recording Paper Tray]

The open and closed states of the recording paper tray 10 will be described bellow referring to FIGS. 4 and 5, in which the trajectory T1 indicates the trajectory of an end section 13 of the recording paper tray 10 when the recording paper tray 10 turns.

That is, the recording paper tray 10 is openable and closable such that the recording paper tray 10 can be opened by turning the same in the direction of an arrow K11 or closed by turning the same in the direction of the arrow K11 along the trajectory T1.

In this manner, since the recording paper tray 10 is openable and closable, it is possible to keep the recording paper tray 10 closed when the facsimile machine 1 is unused as shown in FIG. 4, or open the recording paper tray 10 as shown in FIG. 5.

The closed state of the recording paper tray 10 denotes a state in which the recording paper tray 10 is closed in the direction of the arrow K12 as shown in FIG. 4. When the recording paper tray 10 is in the closed state, the recording paper tray 10 is in a state of being still above the maintenance cover 20.

On the other hand, the closed state of the recording paper tray 10 denotes a state in which the recording paper tray 10 is opened in the direction of the arrow K11 as shown in FIG. 5.

[Open and Closed States of Maintenance Cover]

The open and closed states of the maintenance cover will be described as follows referring to FIGS. 4, 6, and 1.

As shown in FIGS. 6 and 1, the maintenance cover 20 can open by turning in the direction of the arrow K21 about the axis P2 as a turning axis or close by turning in the direction of the arrow K22 about the axis P2.

This embodiment has a structure in which the front panel 50 is opened forward and then the maintenance cover 20 is lifted up in order to open the maintenance cover 20. Here, a description on the movement of the front panel 50 will not be given. Also, this embodiment may adopt any structure for the front panel 50 in place of the structure in which the front panel 50 is opened forward before opening the maintenance cover 20.

The closed state of the maintenance cover 20 denotes a state in which the maintenance cover 20 is closed in the direction of the arrow K12 as shown in FIG. 4. That is, the closed state of the maintenance cover 20 means a state of storing the printing processing section.

In FIG. 6, a line B-B passing through the end section 23 of the maintenance cover 20 and the axis P2 is considered a reference line H-H serving as a reference in the closed state of the maintenance cover 20.

On the other hand, the open state of the maintenance cover 20 denotes a state in which the maintenance cover 20 is caused to turn in the direction of the arrow K21 so as to expose the print processing section as shown in FIGS. 1 and 6.

In FIG. 1, the reference line H-H and the line B-B, which passes through the end section 23 of the maintenance cover 20 and the axis P2, make a turning angle θ of substantially 90°. In FIG. 6, the turning angle θ is substantially 70°.

That is, in the facsimile machine 1, the maintenance cover 20 can be turned to be brought in the open state for exposing the print processing section. The user can access the print processing section by bringing the maintenance cover 20 in the open state for the purpose of maintenance or the like.

Arrangements of the facsimile machine 1 in respective states will be hereinafter described in detail referring to FIGS. 1, 4, 5, and 6.

[When Both Recording Paper Tray and Maintenance Cover are in Closed States]

First, referring to FIG. 4 again, an arrangement of the facsimile machine 1 when both the recording paper tray 10 and the maintenance cover 20 are in the closed states will be described.

As previously described, in FIG. 4, the reference line H-H and the line B-B, which passes through the end section 23 of the maintenance cover 20 and the axis P2, make a turning angle θ of 0°.

An arrangement around the axis P1 of the recording paper tray 10, the axis P2 of the maintenance cover 20, and the axis P3 of the paper feeding guide 30 will be described as follows with reference to the main-part-enlarged view W1 shown in FIG. 4.

As shown in the main-part-enlarged view W1, the projecting section 11 is provided at a hinge section 12 of the recording paper tray 10. The projecting section 11 is provided, at the hinge section 12, at a position on the circumference of the axis P1 and slightly closer to the back.

The main-part-enlarged view W1 shows, as a trajectory C1, the trajectory made by the end of the projecting section 11 when the recording paper tray 10 turns. That is, the trajectory C1 indicates the range within which the projecting section 11 turns. As the trajectory C1 in the main-part-enlarged view W1 shows, even when the recording paper tray 10 turns, the projecting section 11 within its turning range does not come in contact with the paper feeding guide 30.

The support section 33 is in contact with the guiding section 42 and presses a sheet carrying surface against the paper feeding roller 21 by supporting the paper feeding guide 30 using the guiding section 42 as a base. The sheet carrying surface is made of an elastic body and holds the sheet between the paper feeding roller 21 and the sheet carrying surface. In other words, the supporting section 33 supports and keeps in a predetermined position the paper feeding guide 30, which may otherwise turn in the direction of gravitational force. In this manner, the paper feeding guide 30 and the paper feeding roller 21 form a carrying path for guiding the sheet of recording paper set on the recording paper tray 10 to the thermal head 41 and the like.

On the circumference of the axis P3 and at a position above the axis P3 and slightly closer to the back of the device, a locking section 31 and a projecting section 32 are provided. That is, in the paper feeding guide 30, the locking section 31 and the projecting section 32 are positioned on the side opposite, with respect to the axis P3, to the sheet carrying surface, which is being pressed against the paper feeding roller 21 by the supporting section 33.

The circumference C3 indicates a circle having a radius that is a line connecting between the axis P3 and the end of the locking section 31. The circumference C3 is in such a positional relation with the projecting section 11 that the circumference C3 does not intersect with the projecting section 11 when the recording paper tray 10 and the maintenance cover 20 are in the closed states. Thus, the locking section 31 is in such a positional relation with the projecting section 11 that the locking section 31 does not come in contact with the projecting section 11 even if the paper feeding guide 30 turns.

[When Maintenance Cover is in Closed State and Recording Paper Tray is in Open State]

Next, referring to FIG. 5 again, an arrangement of the facsimile machine 1 when the maintenance cover 20 is in the closed state and the recording paper tray 10 is in the open state will be described.

In using the facsimile machine 1, only the recording paper tray 10 is brought in the open state as shown in FIG. 5. The facsimile machine 1 is used, for example, in transmitting a facsimile and receiving a facsimile, and the like.

Arrangements of the maintenance cover 20 and the paper feeding guide 30 are the same as in the case where the recording paper tray 10 and the maintenance cover 20 are both in the closed states.

As one example of use of the facsimile machine 1, the movement in printing a facsimile will be described as follows. Sheets of recording paper set on the recording paper tray 10 are sequentially carried in the direction indicated by a paper feeding regular route L1 in the printing process. That is, the sheet of recording paper set on the recording paper tray 10 is carried by the paper feeding roller 21 to the inside of the facsimile machine 1. In this way, the sheet of paper to be carried is guided through the carrying path formed by the paper feeding roller 21 and the sheet carrying surface being pressed against the paper feeding roller 21, and then guided to the position where the thermal head 41 is arranged.

Then a thermal transfer film fed from the ribbon and the sheet of recording paper are carried by the platen roller 22, and the printing by thermal transfer is carried out at the thermal head 41. Subsequently, the sheet of recording paper after being subject to the printing is carried away therefrom and discharged to the upper surface of the maintenance cover 20.

An arrangement around the axis P1 of the recording paper tray 10, the axis P2 of the maintenance cover 20, and the axis P3 of the paper feeding guide 30 will be described as follows with reference to the main-part-enlarged view W2 shown in FIG. 4.

As previously described, the projecting section 11 is in such a positional relation with the paper feeding guide 30 that the projecting section 11 within its turning range does not come in contact with the paper feeding guide 30 as shown by the trajectory C1. That is, since the projecting section 11 has a clearance between the paper feeding guide 30 secured, the projecting section 11 is not in such a positional relation that the projecting section 11 comes in contact with the locking section 31 of the paper feeding guide 30 or other components, even when the recording paper tray 10 turns. Thus, since the paper feeding guide 30 does not prevent the turning of the recording paper tray 10, the recording paper tray 10 can be switched from the closed state into the open state by being turned.

[Example 1 When Maintenance Cover is in Closed State]

Next, referring to FIG. 6 again, an example of an arrangement of the facsimile machine 1 when the maintenance cover 20 is in the open state will be described below.

In FIG. 6, the reference line H-H and the line B-B, which passes through the end section 23 of the maintenance cover 20 and the axis P2, make a turning angle θ of substantially 70°. That is, the maintenance cover 20 is in a state of being open in the direction of the arrow K21 at about 70°.

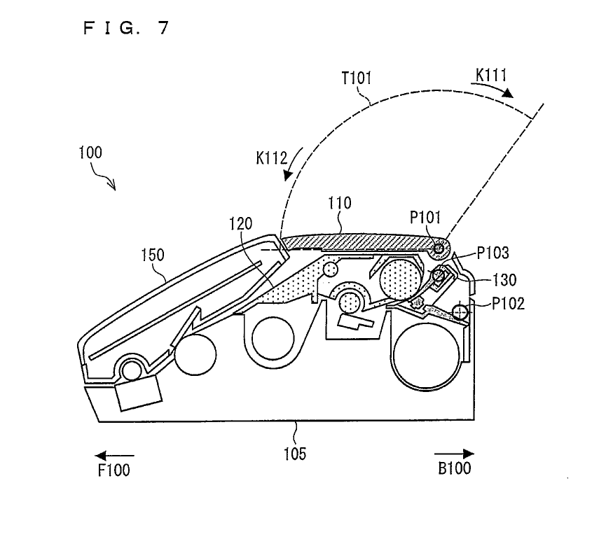

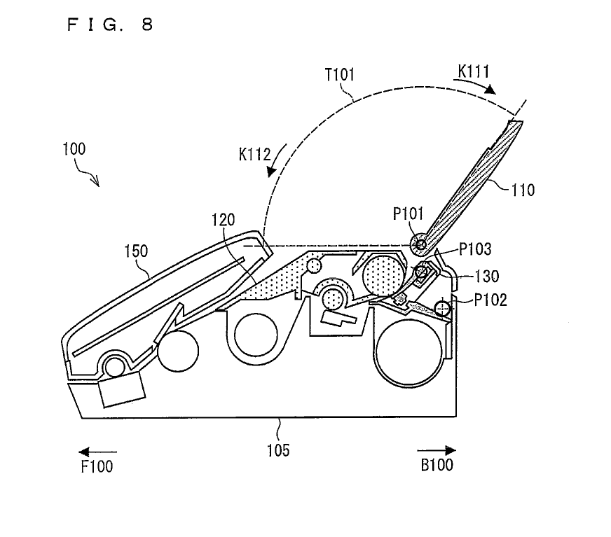

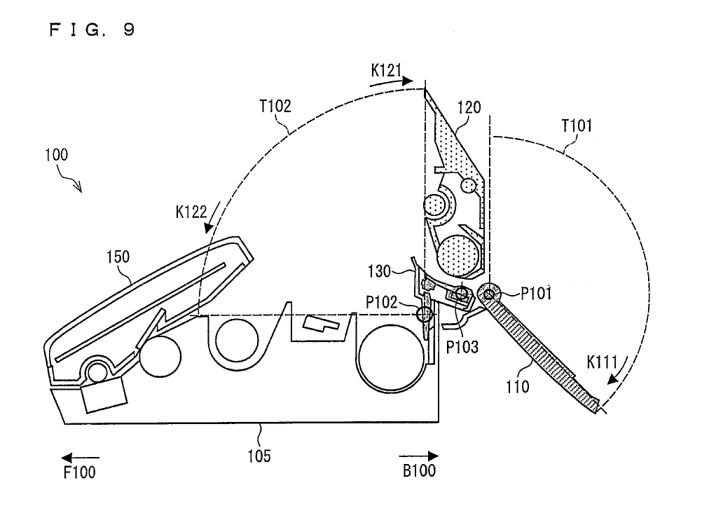

As previously shown with reference to FIGS. 7 to 9, in the conventional facsimile machine 100, the maintenance cover 120 opens from the state of being open at about 70° to the limit of the operational range by turning due to its own weight in the direction of the arrow K111, as shown in FIG. 9.

On the other hand, in the facsimile machine 1 in accordance with this embodiment, the turning of the recording paper tray 10 can be prevented even in such state. The mechanism of preventing the turning of the recording paper tray 10 will be described as follows with reference to the main-part-enlarged view W3 shown in FIG. 6.

As shown in the main-part-enlarged view W3, the projecting section 11 provided at the hinge section 12 of the recording paper tray 10 is in such a positional relation that the projecting section 11 is substantially in contact with the locking section 31 of the paper feeding guide 30. Consequently, even when the recording paper tray 10 tries to turn in the direction of the arrow K11, the projecting section 11 is brought into contact with the locking section 31, so that the turning movement of the recording paper tray 10 is prevented.

The projecting section 11 and the locking section 31 are in such positional relation with each other due to the following reason.

First, since the paper feeding guide 30 is provided to the maintenance cover 20, the paper feeding guide 30 turns in accordance with the turning of the maintenance cover 20.

Specifically, in association with the maintenance cover 20 turning to open in the direction of the arrow K21, the axis P3 of the paper feeding guide 30 turns about the axis P2 serving as a turning axis. That is, when the maintenance cover 20 turns in the direction of the arrow K21 at about 70° , the position of the axis P3 turns 70° about the axis P2 as a turning axis. In this manner, the axis P3 moves in the direction of the back of the device.

In association with the movement of the axis P3, the end section 34 of the supporting section 33 slides on the surface of the guiding section 42. The supporting section 33 supports the paper feeding guide 30 using the guiding section 42 as a base while sliding on the surface of the guiding section 42. In this manner, the paper feeding guide 30 turns in the direction of an arrow K31 about the axis P3 as a turning axis.

As a result, the projecting section 11 and the locking section 31 are brought in such a positional relation that the projecting section 11 and the locking section 31 are substantially in contact with each other, thereby enabling the prevention of the turning of the recording paper tray 10.

On the other hand, as for the positional relation between the paper feeding roller 21 and the paper feeding guide 30, as the maintenance cover 20 gradually turns to open in the direction of the arrow K21, the paper feeding guide 30 relatively departs from the paper feeding roller 21. Owing to this, in a paper jamming or the like, for example, it is possible to release the sheet of recording paper between the paper feeding guide 30 and the paper feeding roller 21.

That is, the paper feeding guide 30 and the paper feeding roller 21 are brought in such a positional relation with each other that enables the sheet of recording paper to be released from the carrying path formed by the paper feeding guide 30 and the paper feeding roller 21.

In this embodiment, the angle at which the paper feeding guide 30 turns in the direction of the arrow K31 about the axis P3 as a turning axis is smaller than the turning angle of the maintenance cover 20.

[Example 2 When Maintenance Cover is in Open State]

Next, referring to FIG. 1 again, another example of an arrangement of the facsimile machine 1 when the maintenance cover 20 is in the open state will be described below.

As previously described, in FIG. 1, the reference line

H-H and the line B-B, which passes through the end section 23 of the maintenance cover 20 and the axis P2, make a turning angle θ of substantially 90°.

An arrangement of the axis P1 of the recording paper tray 10, the axis P2 of the maintenance cover 20, and the axis P3 of the paper feeding guide 30 will be described as follows with reference to the main-part-enlarged view W1 shown in FIG. 1.

As preciously described, in association with the turning of the maintenance cover 20, the end section 34 of the supporting section 33 slides on the guiding section 42. This results in the turning of the paper feeding guide 30.

The turning angle of the maintenance cover 20 shown in FIG. 1 is larger than that in FIG. 6. Consequently, in the main-part-enlarged view W1, the paper feeding guide 30 turns further than the state shown in the main-part-enlarged view W3, and both the locking section 31 and the projecting section (movement preventing section) 32 are in contact with the projecting section 11.

In this manner, the locking section 31 comes in contact with the projecting section 11 to thereby prevent the turning of the recording paper tray 10. Further, the projecting section 32 comes in contact with the projecting section 11 to thereby prevent shaking of the recording paper tray 10 so as to stabilize the prevention of the turning of the recording paper tray 10 by the locking section 31.

Here, the projecting section 32 may be configured such that, when the maintenance cover 20 is in the open state, the projecting section 32 prevents the movement of the projecting section 11 to any direction other than the direction in which the turning section 11 turns when the recording paper tray 10 opens in the direction of the arrow K11.

That is, in the paper feeding guide 30, the projecting section 32 may be provided at a position where the projecting section 32 comes in contact with a surface of the projecting section 11 in the direction of the axis P1 when the maintenance cover 20 is in the open state. In other words, in the paper feeding guide 30, the projecting section 32 may be provided at a position that is shifted from the position of the projecting section 11 in a direction substantially perpendicular to the arrow K21 or the arrow K22 when the maintenance cover 20 is in the open state, so that the projecting section 32 and the projecting section 11 are brought into contact with each other.

The above configuration prevents shaking of the recording paper tray 10 in the direction of the axis P1 when the maintenance cover 20 is in the open state.

[Advantages]

A facsimile machine 1 of the present invention includes the printing processing section which includes the thermal head 41, the ribbon 43, and the platen roller 22, the maintenance cover 20 turnably attached to the device body, the maintenance cover turning between the closed state for storing the printing processing section and the open state for exposing the printing processing section, the recording paper tray 10 for setting a sheet of recording paper thereon, the recording paper tray 10 being turnably attached to the maintenance cover 20, so that the recording paper tray 10 is turnable with respect to the maintenance cover 20, the paper feeing guide 30 for guiding the sheet set on the recording paper tray 10 to the printing processing section, the paper feeing guide 30 being turnably attached to the maintenance cover 20, so that the paper feeding guide 30 is turnable with respect to the maintenance cover 20. The recording paper tray 10 is provided with the projecting section 11 turning in association with the turning of the recording paper tray 10 turnably attached to the maintenance cover 20, and the paper feeding guide 30 is provided with the locking section 31 which, (i) when the maintenance cover 20 is in the open state, moves to the locking position in association with the turning of the paper feeding guide 30 turnably attached to the maintenance cover 20, the locking position being a position at which the locking section 31 locks the projecting section 11 so as to prevent the turning of the recording paper tray 10, and (ii) when the maintenance cover 20 is in the closed state, moves to the releasing position in association with the turning of the paper feeding guide 30 turnably attached to the maintenance cover 20, the releasing position being a position at which the locking section 31 releases the projecting section 11 so as to enable the turning of the recording paper tray 10.

Consequently, the sheet tray can be prevented from opening against the user's will when the cover is in the open state without adding a complicated mechanism.

In the conventional facsimile machine 100 as shown in FIGS. 7 to 9, when the maintenance cover 120 is closed, the paper feeding guide 130 moves to the position for forming the carrying path for guiding a sheet of recording paper to the processing section, and when the maintenance cover 120 is opened, the paper feeding guide 120 moves to the position for releasing the sheet of recording paper from the carrying path.

Therefore, in the paper feeding guide 130 of such facsimile machine 100, if a component corresponding to the locking section 31 is provided, the component will move to the releasing position when the paper feeding guide 130 is at the position for forming the carrying path for guiding a sheet of recording paper to the processing section, and the component will move to the locking position when the paper feeding guide 130 is at the position for releasing the sheet of recording paper from the carrying path.

Consequently, since the component can be moved using the turning movement of the paper feeding guide 130, it becomes possible to provide a component corresponding to the locking section 31 without a significant change in the structure of the paper feeding guide 130.

In other words, the paper feeding guide 30 places the locking section 31 at the releasing position when the paper feeding guide 30 is, due to the turning of the paper feeding guide 30, at the position for forming the carrying path for guiding the sheet of recording paper to the processing section, and the paper feeing guide 30 places the locking section 31 at the locking position when the paper feeding guide 30 is, due to the turning of the paper feeding guide 30, at the position for releasing the sheet of recording paper from the carrying path.

[Configuration Example of Projecting Section and Locking Section]

Possible configurations for the projecting section 11 and the locking section 31 with respect to the directions of axes P1, P3 will be described below.

As previously described with reference to FIG. 3, in this embodiment, a connection is made at two points of connection sections D11, D12 between the recording paper tray 10 and the maintenance cover 20, and no axial member is provided between the connection sections D11, 12.

Because of this, it is preferable to provide the projecting section 11 near the connection sections D11, 12. However, the present invention is not limited to this, and if an axial member is provided for the connection sections D11, 12, for example, the projecting section 11 may be continuously formed along the axial member.

Further, the locking section 31 can be provided in a paper feeding guide 30 at a position facing the projecting section 11 according to the shape of the projecting section 11. That is, the locking section 31 may be provided, facing the projecting section 11, near the connection sections D11, 12 or continuously between the connection sections D11, 12. The same applies to the projecting section 32.

The present invention is not limited to the above-described embodiments but allows various modifications within the scope of the claims. In other words, any embodiment obtained by combining technical means appropriately modified within the scope of the claims will also be included in the technical scope of the present invention.

As discussed above, according to the sheet processing device of the present invention including the processing section for processing a sheet, the cover turnably attached to the device body, the cover turning between the closed state for storing the processing section and the open state for exposing the processing section, the sheet tray for setting the sheet thereon, the sheet tray being turnably attached to the cover, so that the sheet tray is turnable with respect to the cover, and the guide for guiding the sheet set on the sheet tray to the processing section, the guide being turnably attached to the cover, so that the guide is turnable with respect to the cover, the sheet tray is provided with the projecting section turning in association with the turning of the sheet tray turnably attached to the cover, and the guide is provided with the locking section which, (i) when the cover is in the open state, moves to the locking position in association with the turning of the guide turnably attached to the cover, the locking position being a position at which the locking section locks the projecting section so as to prevent the turning of the sheet tray, and (ii) when the cover is in the closed state, moves to the releasing position in association with the turning of the guide turnably attached to the cover, the releasing position being a position at which the locking section releases the projecting section so as to enable the turning of the sheet tray.

According to the sheet processing device of the present invention, the guide preferably places the locking section at the releasing position when the guide is, due to the turning of the guide, at the position for forming the carrying path for guiding the sheet to the processing section, and the guide preferably places the locking section at the locking position when the guide is, due to the turning of the guide, at a position for releasing the sheet from the carrying path.

According to the configuration above, a sheet processing device is configured such that, when the cover is in the closed state, the guide moves to the position for forming the carrying path for guiding a sheet to the processing section, and when the cover is in the open state, the guide moves to the position for releasing the sheet from the carrying path. This follows that, when the guide is at the position for forming the path for guiding the sheet to the processing section, the locking section moves to the releasing position, and when the guide is at the position for releasing the sheet from the carrying path, the locking section moves to the locking position.

Consequently, with a sheet processing device having the above-described predetermined configuration, it becomes possible to provide the locking section without a significant change in the structure of the guide since the locking section can be moved by means of the movement of the guide.

Further, according to the sheet processing device of the present invention, the guide preferably includes the movement preventing section for preventing, when the cover is in the open state, movement of the projecting section to any direction other than the direction in which the projecting section turns when the sheet tray opens.

This configuration is advantageous in that, since the locking section prevents not only the turning movement of the projecting section in the turning direction but also the movement of the projecting section to any directions other than the turning direction of the projecting section, the sheet tray can be held more stably when the cover is in the open state.

It will be appreciated that the embodiments and examples specifically presented in the chapter Description of Embodiments are intended for the clarification of the technical content of the present invention. Therefore, such embodiments and examples should not be interpreted in a narrow sense by confining to such specific examples, but instead may be practiced with various modifications within the true spirit of the present invention and the scope of the claims to be described later.

### INDUSTRIAL APPLICABILITY

The present invention is applicable to a sheet processing device in which a sheet such as a thin plate or a sheet of paper is supplied to a processing section. Therefore, the present invention is readily applicable to a printing device or the like as well as a facsimile machine.

### REFERENCE SIGNS LIST

1: FACSIMILE MACHINE (SHEET PROCESSING DEVICE)
5: HOUSING (DEVICE BODY)
10: RECORDING PAPER TRAY (SHEET TRAY)
11: PROJECTING SECTION
12: HINGE SECTION
13: END SECTION
20: MAINTENANCE COVER (COVER)
21: PAPER FEEDING ROLLER
22: PLATEN ROLLER (PROCESSING SECTION)
23: END SECTION
30: PAPER FEEDING GUIDE
31: LOCKING SECTION
32: PROJECTING SECTION (MOVEMENT PREVENTING SECTION)
41: THERMAL HEAD (PROCESSING SECTION)
43: RIBBON (PROCESSING SECTION)
K11, K12, K21, K22: ARROW
P1, P2, P3: AXIS
T1, T2: TRAJECTORY

1. A sheet processing device comprising:
a processing section for processing a sheet;
a cover turnably attached to a device body, the cover turning between a closed state for storing the processing section and an open state for exposing the processing section;
a sheet tray for setting the sheet thereon, the sheet tray being turnably attached to the cover, so that the sheet tray is turnable with respect to the cover; and
a guide for guiding the sheet set on the sheet tray to the processing section, the guide being turnably attached to the cover, so that the guide is turnable with respect to the cover;
wherein the sheet tray is provided with a projecting section turning in association with the turning of the sheet tray turnably attached to the cover, and the guide is provided with a locking section which, (i) when the cover is in an open state, moves to a locking position in association with the turning of the guide turnably attached to the cover, the locking position being a position at which the locking section locks the projecting section so as to prevent the turning of the sheet tray, and (ii) when the cover is in a closed state, moves to a releasing position in association with the turning of the guide turnably attached to the cover, the releasing position being a position at which the locking section releases the projecting section so as to enable the turning of the sheet tray.

2. The sheet processing device according to claim 1, wherein the guide places the locking section at the releasing position when the guide is, due to the turning of the guide, at a position for forming a carrying path for guiding the sheet to the processing section, and the guide places the locking section at the locking position when the guide is, due to the turning of the guide, at a position for releasing the sheet from the carrying path.

3. The sheet processing device according to claim 1, wherein the guide includes a movement preventing section for preventing movement of the projecting section to any direction other than a direction in which the projecting section turns when the sheet tray opens.

4. The sheet processing device according to claim 1, wherein the sheet tray is provided with two connection sections for attaching the sheet tray to the cover turnably and the projecting section is provided to each of the two connection sections.

5. The sheet processing device according to claim 4, wherein the locking section is provided to face the projecting section provided to each of the two connection sections.

6. A facsimile machine provided with the sheet processing device according to claim 1, wherein the sheet processed by the processing section is recording paper and the processing section carries out a printing process of facsimile data on the recording paper.
